(19) United States
(12) Patent Application Publication
(10) Pub. No.: US 2021/0200717 A1
(43) Pub. Date: Jul. 1, 2021

(54) GENERATING FULL METADATA FROM PARTIAL DISTRIBUTED METADATA

(71) Applicant: OATH INC., New York, NY (US)

(72) Inventors: George ALEKSANDROVICH, Hoffman Estates, IL (US); Allie K. WATFA, Urbana, IL (US); Robin SAHNER, Urbana, IL (US); Mike PIPPIN, Sunnyvale, CA (US)

(21) Appl. No.: 16/727,219

(22) Filed: Dec. 26, 2019

(51) Int. Cl. G06F 16/16; G06F 16/901; G06F 16/903; G06F 16/906

(52) U.S. Cl. CPC G06F 16/164; G06F 16/906; G06F 16/90348; G06F 16/9027

(57) ABSTRACT

Disclosed are embodiments for generating a dataset metadata file based on partial metadata files. In one embodiment, a method is disclosed comprising receiving data to write to disk, the data comprising a subset of a dataset; writing a first portion of the data to disk; detecting a split boundary after writing the first portion; recording metadata describing the split boundary; continuing to write a remaining portion of the data to disk; and after completing the writing of the data to disk: generating a partial metadata file for the data, the partial metadata file including the split boundary, and transmitting the partial metadata to a partial metadata collector.

### COPYRIGHT NOTICE

This application includes material that may be subject to copyright protection. The copyright owner has no objection to the facsimile reproduction by anyone of the patent disclosure, as it appears in the Patent and Trademark Office files or records, but otherwise reserves all copyright rights whatsoever.

### BACKGROUND

The disclosed embodiments relate to distributed data processing and, in particular, to techniques for generating metadata files describing distributed datasets.

In big data and distributed processing systems such as Hadoop, it is common to amass large data sets based on, for example, high-velocity data such as clickstream data. For downstream processing of such data, it is frequently common to add additional data to the original data sets (referred to as annotating data). In current systems, adding annotations involves a duplication of the original data, forming a new dataset that includes the original data and the new annotation data. For example, annotating clickstream data comprises copying the entire clickstream data set and adding one or more columns to the data set and then populating these new columns with the annotation data. The result is that current systems are required to read and process entire data sets as well as duplicate the same data across additional files. Frequently, current systems perform this copying multiple times as annotations can be added on already annotate data. Thus, if a previously annotated dataset is annotated again, the original data is copied twice, resulting in three copies of the same data.

### BRIEF SUMMARY

Generally, metadata files are utilized by distributed storage systems to manage datasets. However, such systems generally operate on a single, cohesive dataset. In contrast, the disclosed embodiments describe a new data format wherein annotation datasets are generated and processed as separate files. These separate files must be aligned with a root dataset and are also processed using independent writer tasks. Thus, in current systems, there are no viable techniques for generating metadata for a full dataset when writing is distributed, and datasets must also be aligned to one another. Thus, there is a current need in the art to provide a technique for distributing metadata creation.

The disclosed embodiments solve these and other technical problems by providing a storage layer for a distributed storage system that allows for the creation and access of annotation data layers. In some embodiments, the disclosed embodiments are provided as a storage layer on a Hadoop system, although the disclosed embodiments are not limited to such a system. The various techniques described herein may be implemented as a hybrid file format implemented as a thin wrapper layer on a distributed file system.

In one embodiment, a method is disclosed comprising receiving data to write to disk, the data comprising a subset of a dataset; writing a first portion of the data to disk; detecting a split boundary after writing the first portion; recording metadata describing the split boundary; continuing to write a remaining portion of the data to disk; and after completing the writing of the data to disk: generating a partial metadata file for the data, the partial metadata file including the split boundary, and transmitting the partial metadata to a partial metadata collector.

In another embodiment, a non-transitory computer-readable storage medium for tangibly storing computer program instructions capable of being executed by a computer processor is disclosed, the computer program instructions defining the steps of receiving data to write to disk, the data comprising a subset of a dataset; writing a first portion of the data to disk; detecting a split boundary after writing the first portion; recording metadata describing the split boundary; continuing to write a remaining portion of the data to disk; and after completing the writing of the data to disk: generating a partial metadata file for the data, the partial metadata file including the split boundary, and transmitting the partial metadata to a partial metadata collector.

In another embodiment, an apparatus is disclosed comprising: a processor; and a storage medium for tangibly storing thereon program logic for execution by the processor, the stored program logic causing the processor to perform the operations of receiving data to write to disk, the data comprising a subset of a dataset; writing a first portion of the data to disk; detecting a split boundary after writing the first portion; recording metadata describing the split boundary; continuing to write a remaining portion of the data to disk; and after completing the writing of the data to disk: generating a partial metadata file for the data, the partial metadata file including the split boundary, and transmitting the partial metadata to a partial metadata collector.

### BRIEF DESCRIPTION OF THE FIGURES

FIG. 1 is a system diagram illustrating a distributed processing system according to some embodiments of the disclosure.

FIG. 2A illustrates the physical storage layout of a distributed processing system according to some embodiments of the disclosure.

FIG. 2B illustrates the logical storage layout of a distributed processing system according to some embodiments of the disclosure.

FIG. 3A is a block diagram illustrating a system for generating metadata of a distributed dataset according to some embodiments of the disclosure.

FIG. 3B is a class diagram illustrating a metadata object for a composite dataset according to some embodiments of the disclosure.

FIG. 4A is a flow diagram illustrating a method for generating a partial metadata file during the creation of a dataset according to some embodiments of the disclosure.

FIG. 4B is a flow diagram illustrating a method for generating a full metadata file during the creation of a dataset according to some embodiments of the disclosure.

FIG. 4C is a diagram illustrating a file and split mapping according to some embodiments of the disclosure.

FIG. 4D is a flow diagram illustrating a method for generating a partial metadata file during the annotation of a dataset according to some embodiments of the disclosure.

FIG. 4E is a flow diagram illustrating a method for generating a full metadata file during the annotation of a dataset according to some embodiments of the disclosure.

FIG. 5 is a schematic diagram illustrating a computing device showing an example embodiment of a client or server device that may be used within the present disclosure.

FIG. 6A is a diagram illustrating a mapping process performed in a distributed computing environment using a file-based alignment scheme according to some embodiments of the disclosure.

FIG. 6B is a diagram illustrating a mapping process performed in a distributed computing environment using a stripe-based alignment scheme according to some embodiments of the disclosure.

### DETAILED DESCRIPTION

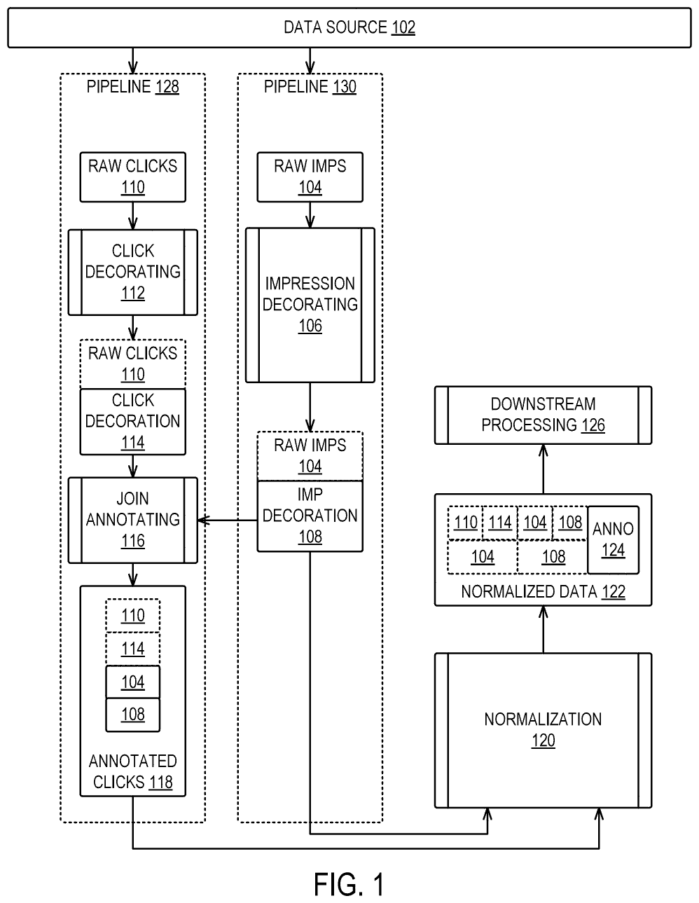

FIG. 1 is a system diagram illustrating a distributed processing system according to some embodiments of the disclosure.

In the illustrated embodiment, a plurality of pipelines (128, 130) process data from a data source (102). In one embodiment, data source (102) can comprise a data lake or similar big data storage device. In the illustrated embodiment, the data source (102) can include a large volume of unstructured data. In some embodiments, the data source (102) can include structured data such as column-oriented data. In some embodiments, the data source (102) can comprise log file data storage or similar types of storage. In some embodiments, the data source (102) stores data in structured filetypes such as Orc or Parquet filetypes.

In the illustrated embodiment, the pipelines (128, 130) comprise distributed processing pipelines. Each pipeline (128, 130) may comprise a plurality of distributed computing devices. In one embodiment, each pipeline (128, 130) can read data from the data source (102), process the data, and load the data into a structured data repository. In some embodiments, all of the above processing may be done in a distributed computing environment running on commodity hardware (e.g., a Hadoop cluster or similar cluster).

The illustrated pipelines (128, 130) further illustrate an annotation workflow. As used herein, annotation refers to the processing of stored data to add new data or supplement the data with existing data. Data to be annotated is referred to as raw data or a raw data set. Additions to the raw data are referred to as annotated data. A combination of raw data and annotated data is referred to as composite data.

In the pipeline (130), raw impression data (104) is received. The use of impression data is provided as an example, and other data types may be used. The embodiments place no limit on the underlying type of data processed herein. The raw impression data (104) can refer to data regarding the display of content in webpages (e.g., the time viewed, the owner of the content, etc.). Raw impression data (104) is generally amassed via log files that log the selection and display of content. In the illustrated embodiment, the raw impression data (104) can comprise a plurality of database columns and rows. In some embodiments, this data can be stored in Orc, Parquet, or other column-oriented data formats.

The raw impression data (104) is processed during an impression decorating stage (106). In the illustrated embodiment, the impression decorating stage (106) can comprise a Pig or Hive script or other similar data processing script. Generally, the impression decorating stage (106) performs one or more operations on the raw impression data (104). For example, the impression decorating stage (106) can add additional columns to the raw impression data or can alias column names.

The output of the impression decorating stage (106) is an impression annotation data set, also referred to as a decorated impression data set (108). As illustrated, the impression decorating stage (106) does not copy the raw impression data (104) to a new location. Instead, the raw impression data (104) is locally processed. That is, the impression decorating stage (106) can comprise a distributed algorithm that is run on the same device that is storing the raw impression data (104). In contrast, however, the decorated impression data (108) is written to disk after being created. In the illustrated embodiment, the decorated impression data set (108) comprises a set of columns capturing only the new data to decorate the raw impression data. The decorated impressions (108) and raw impressions (104) are accessed by pipeline (128) to annotate a clickstream further, as described herein.

Similar to the pipeline (130), pipeline (128) receives raw click data (110). In one embodiment, raw click data (110) can comprise data regarding user selection of digital content. For example, while raw impression data (104) can include rows for each time a piece of content is displayed on a web page, raw click data (110) can include rows for each time that content is selected by a user.

Similar to the impression decorating stage (106), the click decorating stage (112) adds one or more columns or fields to the raw data. As in stage (106), the click decorating stage (112) generates these additional columns for fields as a physically distinct file (114). Thus, the click decorating stage (112) does not modify or copy the raw click data (110) when generating the decorate click data (114).

In the illustrated embodiment, a join annotating stage (116) receives the raw click and impression data (110, 104) and the decorated clicks and impressions (114, 108). In some embodiments, the join annotating stage (116) copies the impression data (104, 108) to form the annotated clicks data set (118). In one embodiment, the join annotating stage (116) filters the impression data (104, 108) to identify only that impression data relevant to the click data (110, 114) and uses the filtered data as an annotation set to generate the annotated clicks.

In the illustrated embodiment, a normalization stage (120) is configured to receive the combined impression composite data set (104, 108) and the composite annotated clicks data set (118). In one embodiment, the normalization stage (120) is configured to add a further annotation to the composite data sets. For example, the normalization stage may perform grouping or sorting of the data as well as synthesized columns based on aggregations of the underlying data. As a result, the normalization stage (20) generates a normalized annotation data set (122). As illustrated, only the annotations (124) are written to disk during this stage, and the remaining data (104, 108, 110, 114) is not copied to a new location on disk.

Finally, the normalized annotation data set (112) is provided to downstream processing applications for analysis, further processing, and storage, as required by such applications. As indicated in the figure via dotted lines, data sets in the pipelines are not copied during the annotation phases. The result is that the normalized data (122) can include the annotation results of the pipeline (128, 130) stages, the normalization annotations, and the raw underlying data without incurring the computationally expensive copying costs required by existing solutions. Specific methods for avoiding this unnecessary copying are described in more detail herein in the context of a distributed computing platform such as Hadoop.

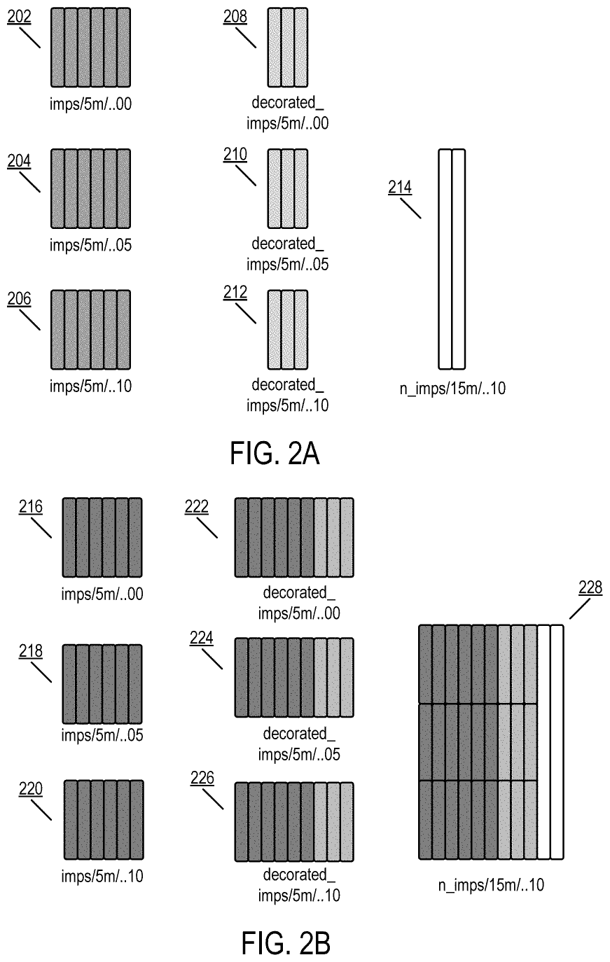

FIG. 2A illustrates the physical storage layout of a distributed processing system according to some embodiments of the disclosure.

In the illustrated embodiment, a set of rows and columns representing raw data is stored at three locations (202, 204, 206). As one example, these locations (202, 204, 206) can comprise three physically distinct storage devices storing a portion of the entire data set represented by the portions. In one embodiment, each location (202, 204, 206) comprises a file, and each file can be stored on the same or different computing devices.

In addition to raw data (202, 204, 206), decoration data is stored in three locations (208, 210, 212). Similar to locations (202, 204, 206), the decoration data is stored in individual files stored on the same or different computing devices. Notably, the decoration data is stored in files separate from the raw data.

Finally, the second level of annotation data is stored at location (214). Again, this location comprises a separate file from the previous locations (202 through 212). Thus, each set of annotations is stored in physically separate files or other structures. Further, there is no limitation on the mapping of the number of files between raw data and annotations. As illustrated, raw data is stored in three files at three locations (202, 204, 206).

Similarly, second level annotation data is also stored in three files at three locations (208, 210, 212). However, the final layer of annotation data is stored in a single file at one location (214). To facilitate this, each annotation structure includes a row identifier that is described in more detail in the application bearing attorney docket number 085804-124100/US.

FIG. 2B illustrates the logical storage layout of a distributed processing system according to some embodiments of the disclosure.

The illustrate storage layout comprises a logical view of the same data depicted physically in FIG. 2A. The illustrated view represents the view of data presented to downstream applications accessing the annotation data sets. In the illustrated embodiment, raw data sets are stored at first locations (216, 218, 220), first annotations are stored at second locations (222, 224, 226), and a third annotation is stored at a third location (228). When accessing the first annotations (222, 224, 226), a downstream processing algorithm accesses both the annotations (e.g., 208) and the raw data (e.g., 202) when accessing the second location (222). Further, when accessing the third location (228), the entire annotation data set appears as a single logical data set while comprising separate physical files.

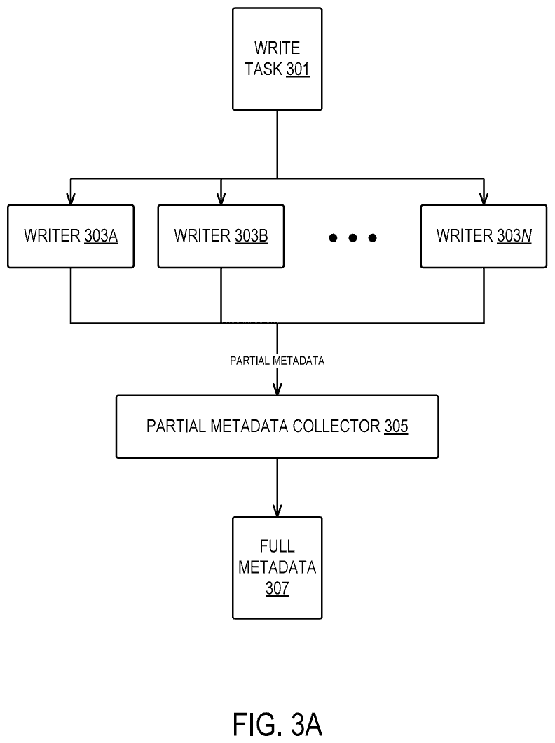

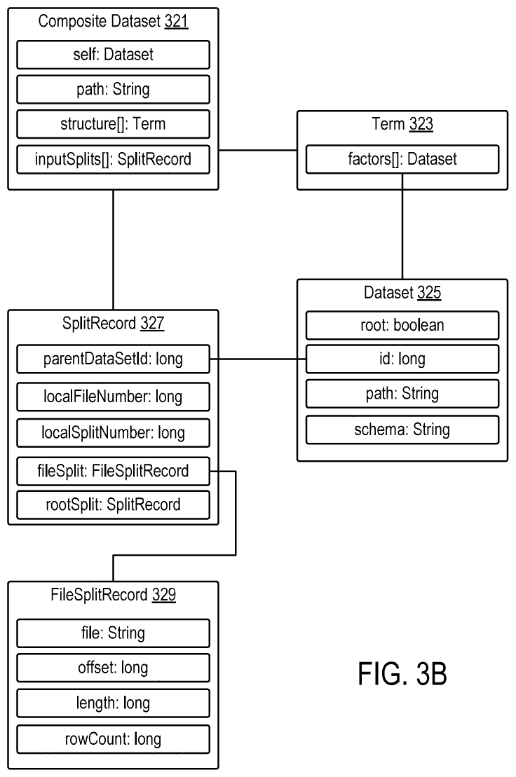

FIG. 3A is a block diagram illustrating a system for generating metadata of a distributed dataset according to some embodiments of the disclosure.

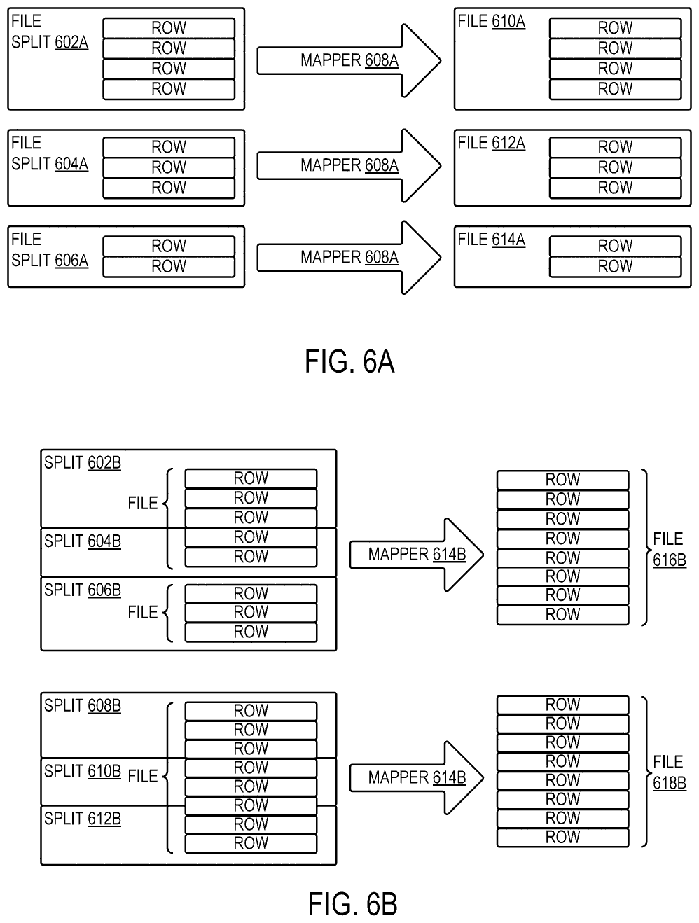

The illustrated embodiment depicts a plurality of writer tasks (303a, 303b, 303n; collectively, 303). Each write task is responsible for writing a portion of a dataset to disk. As discussed in more detail in FIGS. 6A and 6B, a writer generally splits data and writes these splits to one or more files. In some embodiments, there is a one-to-one correspondence between files and splits (as depicted in FIG. 6A). In other embodiments, a single file may include multiple splits (as depicted in FIG. 6b).

In the illustrated embodiment, a write task (301) defines the creation or annotation of datasets. The creation of a dataset refers to the act of creating a new dataset from source data. This source data may comprise raw data or an existing dataset (e.g., copying a dataset). Annotation refers to the addition of one or more additional columns to an existing dataset. In the illustrated embodiment, a write task (301) can comprise a Pig, Hive, or other type of script. In some embodiments, the write task (301) is converted into a directed acyclic graph (DAG).

Further, the write task (301) is partitioned into multiple slices and each slice is handled by a separate reader (303). These readers (303) may be executing on physically distinct computing devices. Alternatively, these readers (303) may be implemented as separate processes on a single device, or a combination of both approaches.

Generally, each of the writers (303) processes a slice of the total data needed for the write task. Thus, if the write task involves writing 10,000 rows and there are 10 writers (303), each writer handles approximately 1,000 rows, although the division may not be evenly split. In general, however, each writer (303) does not know the details of the rows processed by other writers.

As illustrated, each writer (303) generates partial metadata and transmits this partial metadata to a partial metadata collector (305). The partial metadata is generated while the writers (303) execute operations and includes file and split boundaries. In some embodiments, this partial metadata is streamed to the partial metadata collector. In other embodiments, the writers (303) collect the partial metadata while executing and transmit the partial metadata upon completing the requested operations.

Partial metadata collector (305) receives the partial metadata files and generates a full metadata file (307). Details of this operation are provided herein. Further, the format of the full metadata file (307) is depicted in FIG. 3B. In the foregoing description, a metadata file describing the entire dataset can be created despite processing occurring on multiple machines.

FIG. 3B is a class diagram illustrating a metadata object for a composite dataset according to some embodiments of the disclosure.

In the illustrated embodiment, a composite dataset is represented by an object (321). This object (321) is then serialized to generate a metadata file for a given composite dataset. In some embodiments, the object (321) can be serialized into a binary format. In other embodiments, the object (321) can be serialized into a text format (e.g., JavaScript Object Notation (JSON)).

The composite data set object (321) includes a “self” property that comprises a dataset object (discussed in connection with 325). This “self” property represents inter alia the structure of the actual annotation data and storage mechanics. In some embodiments, the properties in a dataset object (e.g., 325) may be flattened into top-level properties of the composite dataset object (321).

The composite data set object (321) additionally includes a path property. The path property represents the location of the given composite dataset on disk and may comprise a relative or, more commonly, an absolute path. In addition to the self and path properties, the composite dataset object (321) may further include various properties such as an identifier that uniquely identifies the dataset in the system. The composite data set object (321) may also include a file count property that represents the number of files constituting the composite dataset. The composite data set object (321) may include a property identifying the number of splits per file and a property identifying the number of rows per split.

The composite data set object (321) additionally includes an inputSplits property. This property comprises an array of SplitRecord objects (described in connection with element 327). This array of SplitRecord objects describes the splits associated with each dataset.

As illustrated, the composite data set object (321) also includes a structure property that represents the flattened, algebraic representation of the composite dataset, described above. The structure property comprises a set of terms (323) that define the structure of the composite dataset. Each term is a summand in the algebraic representation and contains a dataset element for each factor (described in connection with element 325). In the example depicted in FIG. 3A, the structure property would include three terms: X1·Y·Z, X2·Y·Z, and X3·Y·Z

In the illustrated embodiment, a term (323) includes a factors property. The factors property comprises an array of dataset objects (e.g., 325). In the example, depicted in FIG. 3A the term X1·Y·Z would include three factors of X1, Y, and Z.

Each dataset is represented by a dataset object (325). A dataset comprises a directory in the grid storage of the distributing computing environment. In some embodiments, the dataset objects may be normalized such that only one unique copy of a dataset object is stored in the class. In the example in FIG. 3A, only five dataset objects would be instantiated: X1, X2, X3, Y, and Z. Each dataset object (325) has a root property, which indicates whether the dataset is a root or annotation dataset. If true, the dataset comprises the first factor in a term and is used to identify the starting point of the summands. The dataset object (325) additionally includes an identifier (id) property that comprises a unique identifier for the dataset and a path property that identifies the location (absolute or relative) of the dataset on disk. The id is created as a hash using the absolute path to the data and the current time.

The dataset object (325) additionally includes a schema property. In some embodiments, the schema property will include the column names and associated data types for the dataset. In alternative embodiments, the schema property includes only the column names for the dataset. In some embodiments, the schema property comprises a JSON string. In some embodiments, the schema may be in the Avro data format.

As discussed above, the composite dataset object (321) includes a splits property that includes one or more SplitRecord objects. Each SplitRecord object includes details regarding the splits of a given dataset, as described in more detail herein.

A SplitRecord object (327) identifies the details of splits within a given dataset. In some embodiments, a split refers to a file-based split object or a stripe-based split object and generally includes a subset of the total rows of a given dataset. As illustrated, a SplitRecord object (327) includes a parentDataSetId property that identifies the dataset the SplitRecord is associated with. The SplitRecord object (327) includes a fileSplit property that comprises a FileSplitRecord object (329). The fileSplit property represents details generated when implementing a file-based split operation. Alternatively, the fileSplit property may comprise a stripe split property. As illustrated, the FileSplitRecord object (329) includes a file property (identifying the location of the file), an offset property (identifying the offset of the contents of the file in the overall data), a length property (identifying the length of the data in the file), and a rowCount property (identifying the number of rows in the file).

The SplitRecord object (327) additionally includes localFileNumber and localSplitNumber properties. These properties represent the corresponding file number and split number, respectively, for a given SplitRecord. In some embodiments, the SplitRecord object (327) may include further properties describing the details of a given file split or stripe split. In some embodiments, this parameter can refer to an object, including the location of the file/stripe, offset, length, row count, and other details regarding the format of the underlying storage.

Finally, the SplitRecord object (327) includes a rootSplit property that comprises a FileSplitRecord object (329). The rootSplit property represents a split record for the root dataset to which this split is aligned. For a root dataset, this property is set to null.

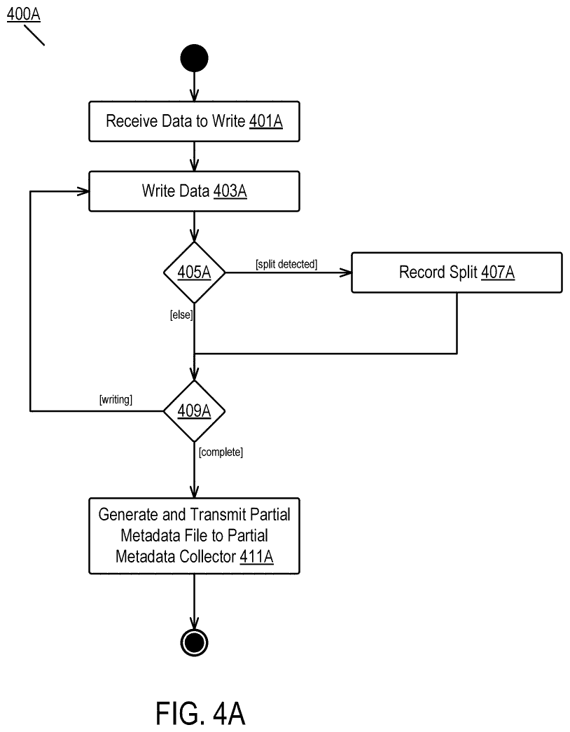

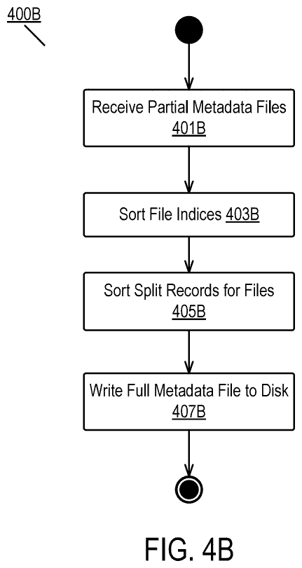

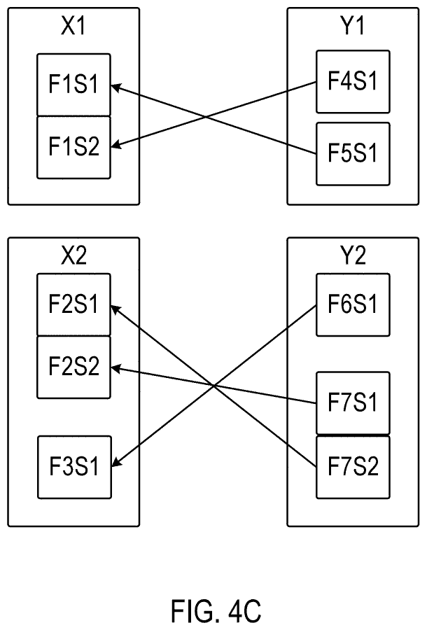

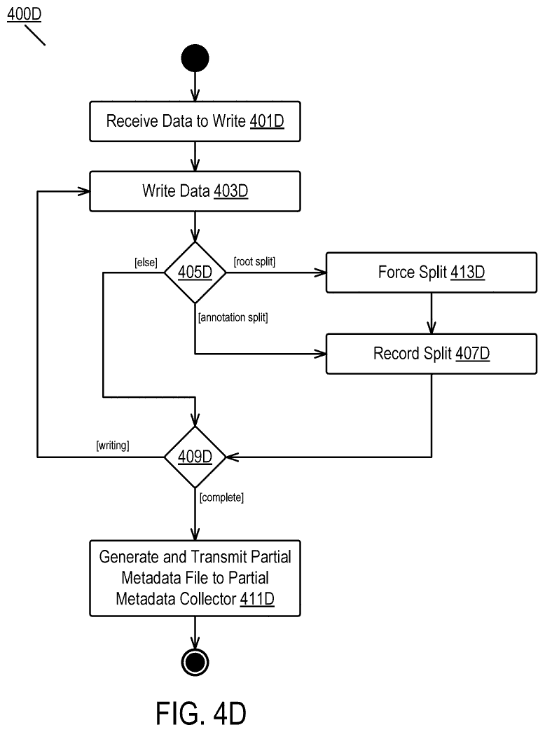

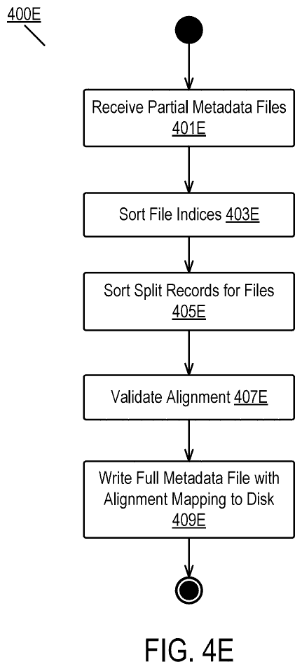

FIG. 4A is a flow diagram illustrating a method for generating a partial metadata file during the creation of a dataset according to some embodiments of the disclosure.

In step 401a, the method (400a) receives data to write. In the illustrated embodiment, the method (400a) is implemented by a writer process. Thus, in step 401a, the method (400a) may receive a subset of an entire dataset to write. In some embodiments, this subset comprises a subset of rows. In other embodiments, the data may comprise a subset of columns to write. In some embodiments, the data may comprise an existing dataset stored by the distributed processing system implementing the method (400a) and formatted based on the underlying file format. Alternatively, in other embodiments, the data may comprise raw data from a comma-separated value (CSV) file, text file, or generally any other type of data. In the illustrated embodiment, the writer process implementing the method (400a) is configured to only write a single file of the dataset.

In step 403a, the method (400a) writes the data to disk. In some embodiments, the method (400a) creates one or more files and begins writing out the received data to disk after processing the data according to one or more operations (described as the write task in FIG. 3A). In one embodiment, the method (400a) maintains a row counter and increments this row counter as rows are written to disk.

In step 405a, the method (400a) determines if a split was detected. In the illustrated embodiment, a split is detected when the current file is getting too large (due to either configuration settings, or being too physically large to fit in memory during processing).

In step 407a, if the method (400a) detects a split boundary, the method (400a) records the split. In one embodiment, the method (400a) records the number of splits detected, the number of rows in the detected split, the offset of the split relative to the first row of data, the length of the split, and an identifier of the file. In some embodiments, the method (400a) transmits this split data to a partial metadata collector (411a). However, in other embodiments, the method (400a) locally records the split record for later use.

After steps 405a or 407a, in step 409a, the method (400a) determines if data is still being written to disk. If so, the method (400a) continues to monitor for splits (steps 403a, 405a, 407a) until all data has been written.

In step 411a, upon detecting that all data was written, the method (400a) generates and transmits a partial metadata file to the partial metadata collector. In one embodiment, the method (400a) combines all of the split records recorded in step 407a into a single file. Additionally, in some embodiments, the method (400a) additionally records the schema of the data written into the partial metadata file. This partial metadata file is then packaged and transmitted to the partial metadata collector for further processing as described in FIG. 4B.

FIG. 4B is a flow diagram illustrating a method for generating a full metadata file during the creation of a dataset according to some embodiments of the disclosure.

In step 401b, the method (400b) receives partial metadata files from a plurality of writers. As described in connection FIG. 3A, the method (400b) can be implemented on a centralized partial metadata collector device. In this embodiment, the method (400b) may receive a signal from each writer indicating they have begun processing. The method (400b) can use these signals to record the number of writers processing a dataset. Then, in step 401b, the method (400b) will await the completion of all writers by comparing the received partial metadata files to the writers and proceeding with processing upon detecting that all writers have transmitted partial metadata files. In another embodiment, the device that executes the method (400b) may initiate each writer executing the method (400a).

In step 403b, the method (400b) sorts the files received from the writers. In the illustrated embodiment, the files are assigned an index based on their position in the dataset. As an initial task, the method (400b) first sorts the file to ensure that the partial metadata files are in the proper order relative to the dataset.

In step 405b, the method (400b) then sorts the split records within each individual file. Prior to step 405b, the individual partial metadata files (and thus writers) are ordered, but the individual file splits within each file are potentially (and likely) out of order. In this step, the method (400b) accesses each file and sorts the individual split records within each file. The method (400b) may sort these split records based on a local split number associated with each split. Alternatively, or in conjunction with the foregoing, the method (400b) may use the offset field to sort the split records.

In step 407b, the method (400b) writes the full metadata file to disk. In one embodiment, the method (400b) concatenates the ordered split records into a flattened array of split records. The method (400b) may then generate the remaining metadata fields described in FIG. 3B. After generating the data structure, the method (400b) may serialize the data structure to disk. In some embodiments, the method (400b) writes the full metadata file to a centralized location on disk for later use.

FIG. 4C is a diagram illustrating a file and split mapping according to some embodiments of the disclosure.

In the illustrated embodiment, X1 and X2 comprise two datasets, and Y1 and Y2 comprise two annotation datasets. In some embodiments, X1 and X2 comprise root datasets.

In the illustrated embodiment, the dataset X1 is stored on disk in a single file (F1). This file (F1) contains two splits (S1 and S2). As one example, the splits (S1 and S2) can comprise chunks of data to write to a grid storage device. Thus, a single file may have an arbitrary number of splits based on memory usage or file size, as described above. Further, these splits (S1 and S2) may be stored in different locations. Similar to X1, dataset X2 comprises two files (F2 and F3). File (F2) includes two splits (S1 and S2) and the file (F3) includes a single split (S1). These files and splits may be generated during the writing of the datasets X1 and X2 as described above, and no limitation is placed on this creation.

As illustrated, datasets Y1 and Y2 comprise annotation data. Generally, each row in the datasets Y1 and Y2 will map to a row in the datasets X1 and X2. As illustrated, dataset Y1 includes two files (F4 and F5), each file storing one split. Dataset Y2 contains two files (F6 and F7) with one file (F6) having a single split and the second file (F7) having two splits. Arrows between files and splits illustrate the mapping between chunks of data in the annotation datasets (Y1, Y2) and the datasets (X1, X2). For example, file/split (F4S1) maps to file/split (F1S2).

As illustrated, when annotating the datasets (X1, X2), there is generally no guarantee that the number of files or splits mirror the files or splits of the original datasets (X1, X2). In the illustrated embodiment, partial metadata is generated during the annotation phase used to generate Y1 and Y2. Like the creation of a dataset (X1, X2), a given writer is assigned to write a given file. However, unlike the creation phase described in connection with FIGS. 4A and 4B, during annotation the system must also properly align data with the corresponding dataset (X1, X2). As an example, a reader may process dataset X1 by reading F1S1 followed by F1S2. However, when reading dataset Y1 in the same manner, the reader would read F4S1 first and F5S1 second. This ordering reverses the direction of the splits and results in misaligned data. Thus, while the reading of X1 starts at row 0 (F1S1), the reading of Y1 begins at row n, where n comprises the first row of F1S2. Furthermore, the number of files in the datasets Y1 and Y2 is not equal to the number of files in datasets X1 and X2, thus the system must further synchronize the differing number of files to ensure that rows are aligned when combining the datasets.

The following FIGS. 4D and 4E describe modifications to the metadata generation process to support this alignment.

FIG. 4D is a flow diagram illustrating a method for generating a partial metadata file during the annotation of a dataset according to some embodiments of the disclosure.

In step 401d, the method (400d) receives data to write. In the illustrated embodiment, the method (400d) is implemented by a writer process. Thus, in step 401d, the method (400d) may receive a subset of an entire dataset to write. In some embodiments, this subset comprises a subset of rows. In other embodiments, the data may comprise a subset of columns to write. In the illustrated embodiment, the data to write comprises annotation data. In this embodiment, annotation data refers to data to add to an existing dataset (e.g., a root dataset).

In step 403d, the method (400d) writes the data to disk. In some embodiments, the method (400d) creates one or more files and begins writing out the received data to disk after processing the data according to one or more operations (described as the write task in FIG. 3A). In one embodiment, the method (400d) maintains a row counter and increments this row counter as rows are written to disk.

In step 405d, the method (400d) determines if a split was detected and what type of split, if any, was detected. In the illustrated embodiment, a split is detected when the current file is getting too large (due to either configuration settings, or being too physically large to fit in memory during processing). This type of split is referred to as an “annotation split” and corresponds to the split discussed in the description of FIG. 4A. If an annotation split is detected, the method (400d) branches to step 407d.

In step 407d, if the method (400d) detects an annotation split boundary, the method (400d) records the split. In one embodiment, the method (400d) may perform step 407d in the same manner described in step 407a. In this embodiment, the method (400d) records the number of splits detected, the number of rows in the detected split, the offset of the split relative to the first row of data, the length of the split, and an identifier of the file. In some embodiments, the method (400d) transmits this split data to a partial metadata collector (411d). However, in other embodiments, the method (400d) locally records the split record for later use.

Alternatively, in step 405d, a split may be detected based on a split in the root split. In this scenario, the method (400d) analyzes the row identifier of the root dataset used to align the annotation and determines if a split has occurred in the root dataset. If so, the method (400d) branches to step 413d. For example, if the method (400d) is annotating a first dataset (X1) with a second dataset (Y1), the method (400d) may analyze the row identifiers of the first dataset X1 to determine when a split occurs in the first dataset. In this scenario, once the method (400d) detects a split in the first dataset (X1), the method (400d) may simulate a split in the annotation dataset. For example, the first dataset may have 2,000 rows with a split at row 1,000. During writing, the annotation dataset may be required to split after the first 800 rows due to a normal split condition occurring (described in FIG. 4A). After splitting, and recording the split, however, the method (400d) will then force a split at row 1,000 of the annotation dataset. Thus, the method (400d) will generate two splits: a first containing 800 rows and a second containing 200 rows. In this manner, at least one split boundary in the annotation dataset maps to a root dataset split, while the annotation split may also include more splits than the root dataset split.

In step 413d, the method (400d) forces a split. In this scenario, the method (400d) intentionally inserts a split boundary to force the method (400d) to record a split despite the underlying data not triggering an annotation split (e.g., the current split does not exceed the maximum size). After forcing a split, the method (400d) proceeds to step 407d, discussed above.

In step 413d, the method (400d) aligns the split.

After steps 405d or 407d, in step 409d, the method (400d) determines if data is still being written to disk. If so, the method (400d) continues to monitor for splits (steps 403d, 405d, 407d) until all data has been written.

In step 411d, upon detecting that all data was written, the method (400d) generates and transmits a partial metadata file to the partial metadata collector. In one embodiment, the method (400d) combines all of the split records recorded in step 407d into a single file. Additionally, in some embodiments, the method (400d) records the schema of the data written into the partial metadata file. This partial metadata file is then packaged and transmitted to the partial metadata collector for further processing, as described in FIG. 4E.

FIG. 4E is a flow diagram illustrating a method for generating a full metadata file during the annotation of a dataset according to some embodiments of the disclosure.

In step 401e, the method (400e) receives partial metadata files from a plurality of writers. As described in connection FIG. 3A, the method (400e) can be implemented on a centralized partial metadata collector device. In this embodiment, the method (400e) may receive a signal from each writer indicating they have begun processing. The method (400e) can use these signals to record the number of writers processing a dataset. Then, in step 401e, the method (400e) will await the completion of all writers by comparing the received partial metadata files to the writers and proceeding with processing upon detecting that all writers have transmitted partial metadata files. In another embodiment, the device that executes the method (400e) may initiate each writer executing the method (400d).

In step 403e, the method (400e) sorts the files received from the writers. In the illustrated embodiment, the files are assigned an index based on their position in the dataset. As an initial task, the method (400e) first sorts the file to ensure that the partial metadata files are in the proper order relative to the dataset.

In step 405e, the method (400e) then sorts the split records within each individual file. Prior to step 405e, the individual partial metadata files (and thus writers) are ordered, but the individual file splits within each file are potentially (and likely) out of order. In this step, the method (400e) accesses each file and sorts the individual split records within each file. The method (400e) may sort these split records based on a local split number associated with each split. Alternatively, or in conjunction with the foregoing, the method (400e) may use the offset field to sort the split records.

In step 407e, the method (400e) validates the alignment of the split records. In the illustrated embodiment, after sorting the splits and files, the method (400e) performs multiple validations to confirm that the splits are properly aligned, all splits are present, and no additional splits were generated that do not map to a root split.

In one embodiment, as part of step 407e, the method (400e) coalesces stripes in the annotation dataset, since it is possible for multiple physical stripes in an annotation dataset to link back to one physical stripe in the root dataset. In one embodiment, the method (400e) performs this coalescing by iterating over the annotation dataset's stripes until the sum of the row counts exactly equal the number of rows in the aligning root split (as indicated by the partial metadata). These records are then combined into a single logical split, and the splits to persist in the annotation dataset's metadata are a collection of these logical splits. The collector then sorts these splits by a tuple comprising the file number and split number, so they are written consistently in the metadata. The final phase before writing involves creating a map between the annotation dataset splits and the corresponding root splits, and saving this link in every annotated split.

In step 409e, the method (400e) writes the full metadata file to disk. In one embodiment, the method (400e) concatenates the ordered split records into a flattened array of split records. The method (400e) may then generate the remaining metadata fields described in FIG. 3B. After generating the data structure, the method (400e) may serialize the data structure to disk. In some embodiments, the method (400e) writes the full metadata file to a centralized location on disk for later use.

FIG. 6A is a diagram illustrating a mapping process performed in a distributed computing environment using a file-based alignment scheme according to some embodiments of the disclosure.

In one embodiment, the illustrated dataset comprises a root dataset, although composite datasets may also be read. Multiple physical files may be read when reading a dataset. As illustrated in FIG. 6A, a dataset is split based on file boundaries into three files (602a, 604a, 606a), each file containing a set of rows. In one embodiment, the system forces the distributed file system to split data based on file boundaries.

The system can generate an annotation dataset using a single mapper. As known in the art, mapper tasks are distributed to data nodes of a Hadoop system. The system causes the system to distribute the map task (608a) to each data node containing the files (602a, 604a, 606a). The map task (608a) is configured to operate on a single file. As described previously, the map task (608a) annotates the rows of a given file (602a, 604a, 606a) and generates annotation row identifiers for the resulting annotation dataset. In the illustrated embodiment, the writing is mapper only: no reduce phase is required to generate the output files (610a, 612a, 614a). In some embodiments, a reducer phase can be implemented if needed by the underlying ETL instructions. If a reducer phase (not illustrated) is included, a separate final partition reducer stage is needed.

The system generates annotation dataset metadata. In one embodiment, this may be performed by a reducer task. In one embodiment, the metadata describes the annotation dataset. The metadata may include structural metadata, split coordination metadata, and a schema. In some embodiments, the metadata for a given annotation set is stored in a file separate from the underlying data.

In general, the output annotation dataset is composed of horizontal and vertical unions of raw datasets. In some embodiments, each annotation dataset is assigned a unique identifier (e.g., a 64-bit identifier). Structural metadata provides the ID of the annotation dataset that the metadata describes as well as the ID's of the datasets from which the annotation dataset is constructed and how those sets are combined with one another. The split coordination metadata describes how the annotation data file is split. In the illustrated embodiment, the split coordination metadata includes a fixed-length array that enumerates all splits in the dataset. In the illustrated embodiment, elements of the array include a relative path name followed by a start and length that covers the entire file. In one embodiment, the schema metadata may comprise a list of columns added via the annotation dataset.

Further detail on metadata files for annotation datasets is provided in co-pending U.S. patent application bearing attorney docket number 085804-124200/US.

The system writes the annotation dataset to disk. As illustrated, the output of the map task (608a) comprises files (610a, 612a, 614a), including rows representing the annotation data. Thus, as a final stage, the mappers (608a) write the annotation datasets to the files identified in the metadata file. Alternatively, if reducer stages are implemented, the reducer may write the files.

FIG. 6B is a diagram illustrating a mapping process performed in a distributed computing environment using a stripe-based alignment scheme according to some embodiments of the disclosure.

The system reads a dataset. In one embodiment, the dataset comprises a root dataset, although composite datasets may also be read. Multiple physical files may be read when reading a dataset. As illustrated in FIG. 6B, a dataset is split based on stripe boundaries into six splits (602b, 604b, 606b, 608b, 610b, 612b), each split containing a set of rows. Although described using stripes, RowGroups or other similar constructs may be used. As illustrated, a given file may span splits (e.g., 602b, 604b).

The system selects a set of stripes from a given dataset. In some embodiments, the system may select a preconfigured number of stripes based on system requirements (e.g., a preferred stripe length for output data). As illustrated in FIG. 6B, the resulting stripes may span multiple files. Thus, a stripe-based alignment mechanism enables a reduced number of data files for an annotation dataset since decisions are premised on stripes rather than files.

The system generates an annotation dataset using a single mapper. As known in the art, mapper tasks are distributed to data nodes of a Hadoop system. The system causes the system to distribute the map task (614b) to each data node containing the stripes (602b, 604b, 606b, 608b, 610b, 612b). The map task (614b) is configured to operate on a set of stripes in one or more splits. As described previously, the map task (614b) annotates the rows of a given split (602b, 604b, 606b, 608b, 610b, 612b) as well as generates annotation row identifiers for the resulting annotation dataset. In the illustrated embodiment, the writing is mapper only, but reducer phases may be added as described previously in connection with FIG. 6A.

The system generates annotation dataset metadata. In one embodiment, this may be performed by a reducer task. In one embodiment, the metadata describes the annotation dataset. The metadata may include structural metadata, split coordination metadata, and a schema, as described in the description of FIG. 6A. In contrast to the metadata generated in FIG. 6A, the split coordination metadata would include more entries containing file paths but would include smaller lengths and non-zero starting locations indicating stripe boundaries.

The system writes the annotation dataset to disk. As illustrated, the output of the map task (614b) comprises files (616b, 618b), including rows representing the annotation data. Thus, as a final stage, the mappers (614b) write the annotation datasets to the files identified in the metadata file. Alternatively, if reducer stages are implemented, the reducer may write the files.

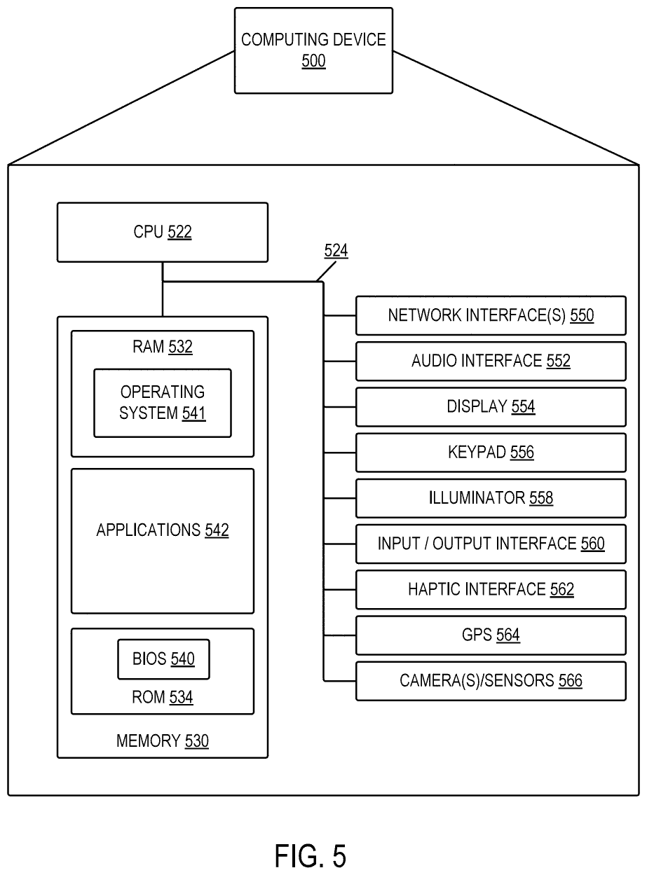

FIG. 5 is a schematic diagram illustrating a computing device showing an example embodiment of a client or server device that may be used within the present disclosure.

The computing device (500) may include more or fewer components than those shown in FIG. 5. For example, a server computing device may not include audio interfaces, displays, keypads, illuminators, haptic interfaces, GPS receivers, cameras, or sensors.

As shown in the figure, the device (500) includes a processing unit (CPU) (522) in communication with a mass memory (530) via a bus (524). Computing device (500) also includes one or more network interfaces (550), an audio interface (552), a display (554), a keypad (556), an illuminator (558), an input/output interface (560), a haptic interface (562), an optional global positioning systems (GPS) receiver (564) and a camera(s) or other optical, thermal, or electromagnetic sensors (566). Device (500) can include one camera/sensor (566), or a plurality of cameras/sensors (566), as understood by those of skill in the art. The positioning of the camera(s)/sensor(s) (566) on the device (500) can change per device (500) model, per device (500) capabilities, and the like, or some combination thereof.

The computing device (500) may optionally communicate with a base station (not shown), or directly with another computing device. Network interface (550) is sometimes known as a transceiver, transceiving device, or network interface card (NIC).

The audio interface (552) is arranged to produce and receive audio signals such as the sound of a human voice. For example, the audio interface (552) may be coupled to a speaker and microphone (not shown) to enable telecommunication with others and/or generate an audio acknowledgment for some action. Display (554) may be a liquid crystal display (LCD), gas plasma, light emitting diode (LED), or any other type of display used with a computing device. Display (554) may also include a touch-sensitive screen arranged to receive input from an object such as a stylus or a digit from a human hand.

Keypad (556) may comprise any input device arranged to receive input from a user. Illuminator (558) may provide a status indication and/or provide light.

The computing device (500) also comprises input/output interface (560) for communicating with external. Input/output interface (560) can utilize one or more communication technologies, such as USB, infrared, Bluetooth™, or the like. The haptic interface (562) is arranged to provide tactile feedback to a user of the client device.

Optional GPS transceiver (564) can determine the physical coordinates of the computing device (500) on the surface of the Earth, which typically outputs a location as latitude and longitude values. GPS transceiver (564) can also employ other geo-positioning mechanisms, including, but not limited to, triangulation, assisted GPS (AGPS), E-OTD, CI, SAI, ETA, BSS, or the like, to further determine the physical location of the computing device (500) on the surface of the Earth. In one embodiment, however, the computing device (500) may through other components, provide other information that may be employed to determine a physical location of the device, including, for example, a MAC address, Internet Protocol (IP) address, or the like.

Mass memory (530) includes a RAM (532), a ROM (534), and other storage means. Mass memory (530) illustrates another example of computer storage media for storage of information such as computer-readable instructions, data structures, program modules or other data. Mass memory (530) stores a basic input/output system (“BIOS”) (540) for controlling the low-level operation of the computing device (500). The mass memory also stores an operating system (541) for controlling the operation of the computing device (500)

Applications (542) may include computer-executable instructions which, when executed by the computing device (500), perform any of the methods (or portions of the methods) described previously in the description of the preceding Figures. In some embodiments, the software and/or programs implementing the method embodiments can be read from hard disk drive (not illustrated) and temporarily stored in RAM (532) by CPU (522). CPU (522) may then read the software and/or data from RAM (532), process them, and store them to RAM (532) again.

For the purposes of this disclosure, a module is a software, hardware, or firmware (or combinations thereof) system, process or functionality, or component thereof, that performs or facilitates the processes, features, and/or functions described herein (with or without human interaction or augmentation). A module can include sub-modules. Software components of a module may be stored on a computer-readable medium for execution by a processor. Modules may be integral to one or more servers or be loaded and executed by one or more servers. One or more modules may be grouped into an engine or an application.

For the purposes of this disclosure, the term “user,” “subscriber,” “consumer” or “customer” should be understood to refer to a user of an application or applications as described herein and/or a consumer of data supplied by a data provider. By way of example, and not limitation, the term “user” or “subscriber” can refer to a person who receives data provided by the data or service provider over the Internet in a browser session, or can refer to an automated software application which receives the data and stores or processes the data.

Those skilled in the art will recognize that the methods and systems of the present disclosure may be implemented in many manners and as such are not to be limited by the foregoing exemplary embodiments and examples. In other words, functional elements being performed by single or multiple components, in various combinations of hardware and software or firmware, and individual functions, may be distributed among software applications at either the client level or server level or both. In this regard, any number of the features of the different embodiments described herein may be combined into single or multiple embodiments, and alternate embodiments having fewer than or more than, all the features described herein are possible.

Functionality may also be, in whole or in part, distributed among multiple components, in manners now known or to become known. Thus, myriad software/hardware/firmware combinations are possible in achieving the functions, features, interfaces, and preferences described herein. Moreover, the scope of the present disclosure covers conventionally known manners for carrying out the described features and functions and interfaces, as well as those variations and modifications that may be made to the hardware or software or firmware components described herein as would be understood by those skilled in the art now and hereafter.

Furthermore, the embodiments of methods presented and described as flowcharts in this disclosure are provided by way of example to provide a complete understanding of the technology. The disclosed methods are not limited to the operations and logical flow presented herein. Alternative embodiments are contemplated in which the order of the various operations is altered and in which sub-operations described as being part of a larger operation are performed independently.

While various embodiments have been described for purposes of this disclosure, such embodiments should not be deemed to limit the teaching of this disclosure to those embodiments. Various changes and modifications may be made to the elements and operations described above to obtain a result that remains within the scope of the systems and processes described in this disclosure.

What is claimed is:

1. A method comprising:
receiving, by a processor, data to write to disk, the data comprising a subset of a dataset;
writing, by the processor, a first portion of the data to disk;
detecting, by the processor, a split boundary after writing the first portion;
recording, by the processor, metadata describing the split boundary;
continuing, by the processor, to write a remaining portion of the data to disk; and
after completing the writing of the data to disk:
generating, by the processor, a partial metadata file for the data, the partial metadata file including the split boundary, and
transmitting, by the processor, the partial metadata to a partial metadata collector.

2. The method of claim 1 further comprising generating alignment data after recording the split boundary, the alignment data comprising metadata aligning the first portion of the data to a root dataset.

3. The method of claim 1, further comprising:
receiving, by the processor, the partial metadata file and a plurality of additional partial metadata files;
sorting, by the processor, the partial metadata file and the plurality of additional partial metadata files to generate a sorted list of partial metadata files;
sorting, by the processor, splits located in each file in the sorted list of partial metadata files; and
writing, by the processor, the sorted list of partial metadata files to disk as a full metadata file.

4. The method of claim 3, further comprising validating alignment of the splits after sorting the splits.

5. The method of claim 1, the recording metadata describing the split boundary comprising reporting a row count of the split.

6. The method of claim 1, the detecting the split boundary comprising detecting that a current file is too large to fit in a memory coupled to the processing device.

7. The method of claim 1, the generating the partial metadata file for the data comprising writing a schema to the partial metadata file.

8. A non-transitory computer readable storage medium for tangibly storing computer program instructions capable of being executed by a computer processor, the computer program instructions defining the steps of:
receiving data to write to disk, the data comprising a subset of a dataset;
writing a first portion of the data to disk;
detecting a split boundary after writing the first portion;
recording metadata describing the split boundary;
continuing to write a remaining portion of the data to disk; and
after completing the writing of the data to disk:
generating a partial metadata file for the data, the partial metadata file including the split boundary, and
transmitting the partial metadata to a partial metadata collector.

9. The non-transitory computer readable storage medium of claim 8, the computer program instructions further defining the step of generating alignment data after recording the split boundary, the alignment data comprising metadata aligning the first portion of the data to a root dataset.

10. The non-transitory computer readable storage medium of claim 8, the computer program instructions further defining the steps of:
receiving the partial metadata file and a plurality of additional partial metadata files;
sorting the partial metadata file and the plurality of additional partial metadata files to generate a sorted list of partial metadata files;
sorting splits located in each file in the sorted list of partial metadata files; and
writing the sorted list of partial metadata files to disk as a full metadata file.

11. The non-transitory computer readable storage medium of claim 10, the computer program instructions further defining the step of validating alignment of the splits after sorting the splits.

12. The non-transitory computer readable storage medium of claim 8, the recording metadata describing the split boundary comprising reporting a row count of the split.

13. The non-transitory computer readable storage medium of claim 8, the detecting the split boundary comprising detecting that a current file is too large to fit in a memory coupled to the processing device.

14. The non-transitory computer readable storage medium of claim 8, the generating the partial metadata file for the data comprising writing a schema to the partial metadata file.

15. An apparatus comprising:
a processor;
a storage medium for tangibly storing thereon program logic for execution by the processor, the stored program logic causing the processor to perform the operations of:
receiving data to write to disk, the data comprising a subset of a dataset,
writing a first portion of the data to disk,
detecting a split boundary after writing the first portion,
recording metadata describing the split boundary,
continuing to write a remaining portion of the data to disk, and
after completing the writing of the data to disk: generating a partial metadata file for the data, the partial metadata file including the split boundary, and transmitting the partial metadata to a partial metadata collector.

16. The apparatus of claim 15 the stored program logic further causing the processor to perform the operations of generating alignment data after recording the split boundary, the alignment data comprising metadata aligning the first portion of the data to a root dataset.

17. The apparatus of claim 15, the stored program logic further causing the processor to perform the operations of:
receiving the partial metadata file and a plurality of additional partial metadata files;
sorting the partial metadata file and the plurality of additional partial metadata files to generate a sorted list of partial metadata files;
sorting splits located in each file in the sorted list of partial metadata files; and
writing the sorted list of partial metadata files to disk as a full metadata file.

18. The apparatus of claim 17, the stored program logic causing the processor to perform the operation of validating alignment of the splits after sorting the splits.

19. The apparatus of claim 17, the recording metadata describing the split boundary comprising reporting a row count of the split.

20. The apparatus of claim 17, the detecting the split boundary comprising detecting that a current file is too large to fit in a memory coupled to the processing device.
